(19) United States
(12) Patent Application Publication
(10) Pub. No.: US 2007/0225184 A1
(43) Pub. Date: Sep. 27, 2007

(54) Amphoteric Fluorescent Whitening Agents in Detergent Formulations

(75) Inventors: Hauke Rohwer, Lorrach (DE); Goetz Scheffler, Grenzach-Wyhlen (DE); Robert Hochberg, Merzhausen (DE); Ullrich Menge, Grenzach-Wyhlen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(73) Assignee: CIBA SPECIALITY CHEMICALS HOLDING INC., Basel (CH)

(21) Appl. No.: 11/578,631

(22) PCT Filed: Apr. 11, 2005
(86) PCT No.: PCT/EP05/51577

§ 371 Date: Oct. 17, 2006

(30) Foreign Application Priority Data
Apr. 20, 2004 (EP) 04101624.7

(51) Int. Cl. C11D 3/42; C11D 3/00

(52) U.S. Cl. 510/103

(57) ABSTRACT

The present invention relates to compositions comprising specific amphoteric fluorescent whitening agents (FWA) and dyefixing, dye transfer inhibition and/or fabric softening agents, formulations for the treatment of textiles comprising such compositions, and the use of such compositions and/or formulations.

The present invention relates to compositions comprising specific amphoteric fluorescent whitening agents (FWA) and dyefixing, dye transfer inhibition and/or fabric softening agents, formulations for the treatment of textiles comprising such compositions, and the use of such compositions and/or formulations.

FWA, also amphoteric FWA are often used in compositions for the treatment of textiles. Such compositions are for example disclosed in EP 850934.

Compositions for the treatment of textiles often comprise dyefixing, dye transfer inhibition and/or fabric softening agents. The disadvantage of such dyefixing, dye transfer inhibition and/or fabric softening agents is that they drastically reduce the efficiency of FWA's.

It has now been found that the use of specific amphoteric FWA's do not show such a drastic loss of effiency when used in combination with dyefixing, dye transfer inhibition and/or fabric softening agents.

Therefore the present invention relates to a composition (C1) comprising

(i) at least one compound of formula (1)

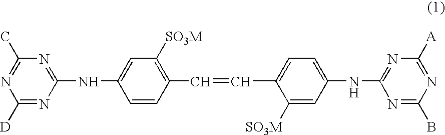

wherein A signifies the moiety of formula (2) or (3)

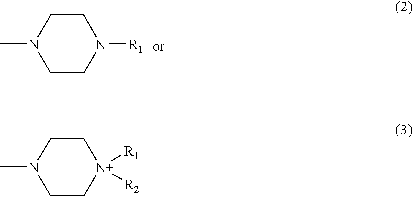

in which
R₁ represents hydrogen; straight-chain C₁-C₁₂alkyl, which may be substituted by one or two —OH, —OC₁-C₄alkyl, —NH₂, —NHC₁-C₄alkyl, —N(C₁-C₄alkyl)₂, —N-pyrrolidino, —N-piperidino, —N-morpholino or —N⁺(C₁-C₄alkyl)₃ groups; branched C₃-C₁₂alkyl group, which may be interrupted by one or two heteroatoms and which may be unsubstituted or substituted by one or two —OH, —OC₁-C₄alkyl, —NH₂, —NHC₁-C₄alkyl, —N(C₁-C₄alkyl)₂, —N-pyrrolidino, —N-piperidino, —N-morpholino or —N⁺(C₁-C₄alkyl)₃ groups; and
R₂ represents C₁-C₄alkyl; C₂-C₄hydroxyalkyl; —CH₂CONH₂; —CH₂COOH or —CH₂COOC₁-C₄alkyl or
A represents a group of the formulae

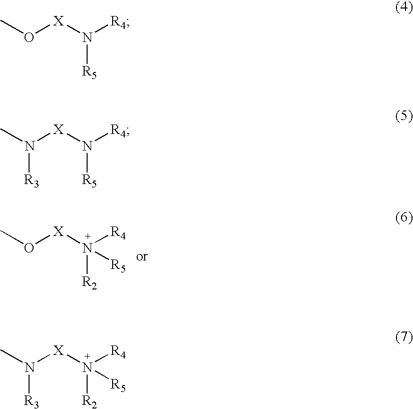

in which
R₃, R₄ and R₅ each, independently of each other, represent hydrogen; C₁-C₄alkyl; C₂-C₄hydroxyalkyl; the group —X′—NR₆R₇ or the group —X′—N⁺R_{6′}R₆R₇, whereby at least one of the substituents R₄ and/or R₅ represents —X′—NR₆R₇ or —X′—N⁺R_{6′}R₆R₇,
X and X′ each, independently of each other, represent a straight-chain C₂-C₈alkylene, which is unsubstituted or substituted by one or two —OH; or branched C₃-C₈alkylene chain, which is unsubstituted or substituted by one or two —OH; —C(═O)—; or a 5-or 6-membered cycloaliphatic ring,
R₆, R_{6′} and R₇ each, independently of each other, represent hydrogen; C₁-C₄alkyl; or, together with the nitrogen atom to which they are bound, complete a pyrrolidino, piperidino or morpholino ring and
R₂ is as previously defined or
A is NR₈R₉,

wherein
R₈ and R₉ each independently of each other, represent hydrogen; C₁-C₈alkyl, wherein the alkyl group may be substituted by C₁-C₄alkoxy, amino, mono- or di-C₁-C₄alkylamino or tri-C₁-C₄alkylammonium; C₂-C₄hydroxyalkyl, wherein the alkyl group may ba substituted by C₁-C₄alkoxy, amino, mono- or di-C₁-C₄alkylamino or tri-C₁-C₄alkylammonium; C₁-C₄alkoxyC₁-C₄alkyl; phenyl, which is unsubstituted or substituted by halogen, C₁-C₄alkoxy, C₁-C₄alkyl, COOM, SO₃M or sulphonamido, or
   R₈ and R₉, together with the nitrogen atom to which they are attached, complete a morpholino-, piperidino- or pyrrolidino-ring, or

A represents halogen,

B and C have independently from each other and from A the same meanings as defined for A, and

D has independently from A the same meanings as defined for A with the exception that D is not halogen, and
M is hydrogen; an alkali metal atom; ammonium or a cation formed from an amine; or a quaternised form thereof,

and

(ii) at least one dyefixing, dye transfer inhibition and/or fabric softening agent.

Preferred embodiments of the present invention are compositions (C2) comprising as component (i) at least one compound of formula (8)

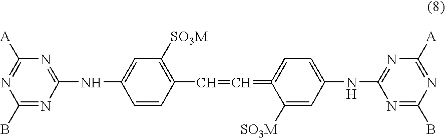

in which
each B is the same or different and each is —NH-Z-N(Rₐ)(R_{b}) or —N-[Z-N(Rₐ)(R_{b})]₂ in which Z is C₂-C₁₄alkylene or optionally substituted arylene, Rₐ and R_{b} are the same or different and each is C₁-C₁₂alkyl, or
   Rₐ and R_{b}, together with the nitrogen atom to which they are each attached, form a morpholino, piperidino or piperazino ring; and
A is NH₂; NH(C₁-C₄alkyl); N(C₁-C₄alkyl)₂; N(CH₂CH₂OH)₂; O—C₁-C₄alkyl; 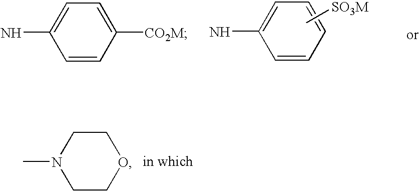
   M is hydrogen; an alkali metal atom; ammonium or a cation formed from an amine; or a quaternised form thereof,

and

(ii) at least one dyefixing, dye transfer inhibition and/or fabric softening agent.

Further preferred embodiments of the present invention are compositions (C3) comprising as component (i) at least one compound of formula (9)

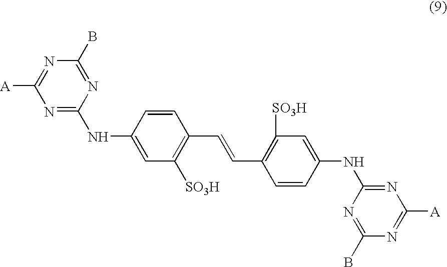

wherein

each A independently of one another, represent the moiety 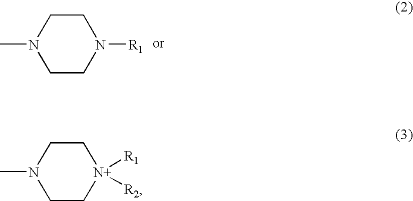
in which
   R₁ represents hydrogen; a straight-chain C₁-C₁₂alkyl or branched C₃-C₁₂alkyl group which
   C₂-C₁₂alkyl and C₃-C₁₂alkyl group, respectively, may be interrupted by one or two heteroatoms and is unsubstituted or substituted by one or two —OH, —OC₁-C₄alkyl, —NH₂, —NHC₁-C₄alkyl, —N(C₁-C₄alkyl)₂, —N-pyrrolidino, —N-piperidino, —N-morpholino or —N⁺(C₁-C₄alkyl)₃ groups and
   R₂ represents C₁-C₄alkyl; C₂-C₄hydroxyalkyl; —CH₂CONH₂; —CH₂COOH or —CH₂COOC₁-C₄alkyl or, alternatively,

each A independently of one another, represent a group of the formula 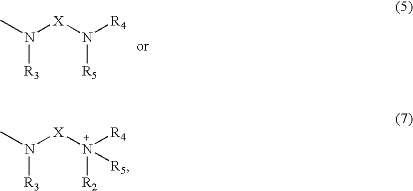
in which
   R₃, R₄ and R₅ each, independently of each other, represent hydrogen; C₁-C₄alkyl; C₂-C₄hydroxyalkyl; the group —X′—NR₆R₇ or the group —X′—N⁺R_{6′}R₆R₇, whereby at least one of the substituents R₄ and/or R₅ represents —X′—NR₆R₇ or —X′—N⁺R_{6′}R₆R₇, X and X′ each, independently of each other, represent a straight-chain C₂-C₈alkylene or branched C₃-C₈alkylene chain, which is unsubstituted or substituted by one or two —OH or —C(═O)— groups,
   R₆, R_{6′} and R₇ each, independently of each other, represent hydrogen; C₁-C₄alkyl or, together with the nitrogen atom to which they are bound, complete a pyrrolidino, piperidino or morpholino ring and
   R₂ is as previously defined and each

each B independently of one another, is either defined as for A or represent halogen; —NH₂;
C₁-C₄monoalkyl- or dialkylamino, said alkyl groups being unsubstituted or substituted by C₁-C₄alkoxy, amino, mono- or di-C₁-C₄alkylamino or tri-C₁-C₄alkylammonium; C₂-C₄hydroxyalkylamino; C₂-C₄di(hydroxyalkyl)amino; anilino; an aniline monosulphonic acid or sulphonamide residue or a 5- or 6-membered, saturated heterocyclic ring,

and

(ii) at least one dyefixing, dye transfer inhibition and/or fabric softening agent.

Further preferred embodiments of the present invention are compositions (C4) comprising as component (i) at least one compound of formulae (10), (11), and/or (12)

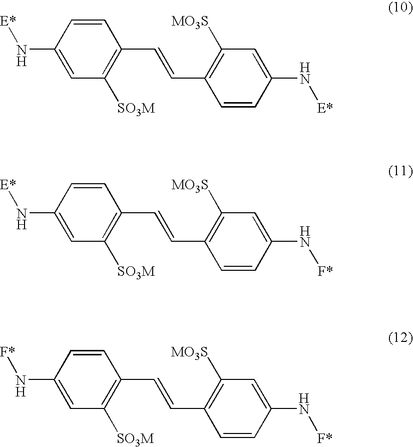

in which

E* represents a group of the formula 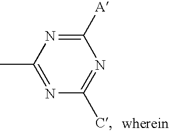
wherein

A′ represents —X—Y—NR₃R₄ and

C′ is —NR₁R₂ and

F* represents a group of the formula

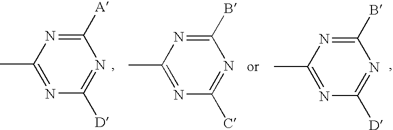

wherein
D′ represents —NR₅R₆ and
B′ represents —X₁—Y₁—NR₇R₈, whereby
X and X₁ each, independently of each other, represent —O— or —NH—,
Y and Y₁ each, independently of each other, represent a straight-chain C₂-C₈alkylene or branched C₃-C₈alkylene chain, which may be interrupted by one or two nitrogen, oxygen or sulphur atoms or represent a 5- or 6-membered cycloaliphatic ring, preferably cyclohexyl,
R₁, R₂, R₅ and R₆ each independently of each other, represent hydrogen; C₁-C₈alkyl; C₂-C₄hydroxyalkyl; C₁-C₄alkoxyC₁-C₄alkyl; phenyl, which is unsubstituted or substituted by halogen, C₁-C₄alkoxy, C₁-C₄alkyl or sulphonamido, or
   R₁ and R₂ and/or R₅ and R₆, together with the nitrogen atom to which they are attached, complete a morpholino-, piperidino- or pyrrolidino-ring,
R₃, R₄, R₇ and R₈ each independently of each other, represent hydrogen; C₁-C₄alkyl; C₂-C₄hydroxyalkyl or
   R₃ and R₄ and/or R₇ and R₈, together with the nitrogen atom to which they are attached, complete a morpholino-, piperidino- or pyrrolidino-ring and
M represents hydrogen; an alkaline or alkaline earth metal; ammonium or alkyl ammonium,

and

(ii) at least one dyefixing, dye transfer inhibition and/or fabric softening agent.

The compounds of formula (1) are known for example from WO03/078406, EP 413926 and EP 850943 and can be produced according to known processes.

As component (ii) any suitable dyefixing, dye transfer inhibition and/or fabric softening agent can be used, for example polymeric dye transfer inhibition and/or polymeric dye-fixing agents.

Polymeric dye transfer inhibiting agents are preferably polyvinylpyrrolidones, polyvinylimidazole, polyvinylpyrrolidone/polyvinylimidazole-copolymer or polyvinylpyridine-N-oxides which may have been modified by the incorporation of anionic or cationic substituents, especially those having a molecular weight in the range of from 5,000 to 60,000, more especially from 5,000 to 50,000. Such polymers are usually used in an amount of from 0.01 to 5% by weight (wt-%), preferably 0.05 to 5 wt-%, especially 0.01 to 2 wt-%, based on the total weight of the detergent. Preferred dye fixatives are those given in WO 02/02865 (see especially page 1, last paragraph and page 2, first paragraph) and WO 03/057815 (see especially page 2, last 2 paragraphs and page 3, first paragraph).

Another preferred dye-fixing agent based on basic polycondensation products of an amine of formula (13)

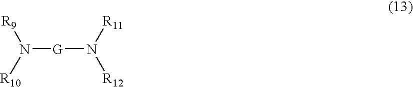

and a cyanamide, which polycondensation products are completely or partially neutralised with an inorganic or organic acid,

R₉, R₁₀, R₁₁ and R₁₂ each independently of the others being hydrogen or alkyl that is unsubstituted or substituted by amino, hydroxy, cyano or by C₁-C₄alkoxy and G being alkylene optionally substituted or interrupted by one or more hetero atoms.

G in formula (1) is preferably C₂-C₂₀alkylene optionally interrupted by —O—, —S—, —NH— or by —N(C₁-C₄alkyl)- and/or substituted by hydroxy, especially C₂-C₂₀alkylene interrupted one or more times by —NH—.

R₉, R₁₀, R₁₁ and R₁₂ preferably are each independently of the others hydrogen or C₁-C₄alkyl.

Examples of suitable compounds of formula (13) are 1,4-butanediamine, 1,6-hexanediamine, dipropylenetriamine, N-(2-aminoethyl)-1,3-propanediamine, N,N-bis(2-aminopropyl)methyl-amine, polyethyleneimines and polyethylenepolyamines such as diethylenetriamine, triethylenetetramine, tetraethylenepentamine and pentamethylenehexamine. Preferred compounds of formula (13) are polyethylenepolyamines and, among those, especially diethylenetriamine. The number of repeating units of monomers of formula (13) in the basic polycondensation products is, for example, from 4 to 100, especially from 4 to 50.

Suitable cyanamides are, for example, cyanamide, dicyandiamide, guanidine and biguanidine. Preference is given to dicyandiamide.

The above-mentioned dye-fixing agents are known, for example, from EP-A-692 511, WO 99/64550, EP-A-1303665, WO 03/057815 and WO 01/74982 and can be obtained by the method disclosed therein.

The softener compounds can be any common softener compound as well as mixtures of fabric softener compounds.

Fabric softener components, especially hydrocarbon fabric softener components, suitable for use herein are selected from the following classes of compounds:

(i) Cationic quaternary ammonium salts. The counter ion of such cationic quaternary ammonium salts may be a halide, such as chloride or bromide, methyl sulphate, or other ions well known in the literature. Preferably the counter ion is methyl sulfate or any alkyl sulfate or any halide, methyl sulfate being most preferred for the dryer-added articles of the invention.

Examples of cationic quaternary ammonium salts include but are not limited to:

(1) Acyclic quaternary ammonium salts having at least two C₈-C₃₀—, preferably C₁₂-C₂₂-alkyl or alkenyl chains, such as: ditallowdimethyl ammonium methylsulfate, di(hydrogenated tallow)dimethyl ammonium methylsulfate, di(hydrogenated tallow)dimethyl ammonium methylchloride, distearyldimethyl ammonium methyl-sulfate, dicocodimethyl ammonium methylsulfate and the like. It is especially preferred if the fabric softening compound is a water insoluble quaternary ammonium material which comprises a compound having two C₁₂-C₁₈-alkyl or alkenyl groups connected to the molecule via at least one ester link. It is more preferred if the quaternary ammonium material has two ester links present. An especially preferred ester-linked quaternary ammonium material for use in the invention can be represented by the formula:

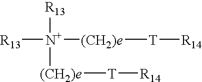

wherein each R₁₃ group is independently selected from C₁ to C₄ alkyl, hydroxyalkyl or C₂-C₄-alkenyl groups; T is either —O—C(O)— or —C(O)—O—, and wherein each R₁₄ group is independently selected from C₈-C₂₈-alkyl or alkenyl groups; and e is an integer from 0 to 5.

A second preferred type of quaternary ammonium material can be represented by the formula:

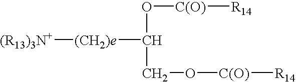

wherein R₁₃, e and R₁₄ are as defined above.

(2) Cyclic quaternary ammonium salts of the imidazolinium type such as di(hydrogenated tallow)dimethyl imidazolinium methylsulfate, 1-ethylene-bis(2-tallow-1-methyl)imidazolinium methylsulfate and the like;

(3) Diamido quaternary ammonium salts such as: methyl-bis(hydrogenated tallow amidoethyl)-2-hydroxethyl ammonium methyl sulfate, methyl bi(tallowamidoethyl)-2-hydroxypropyl ammonium methylsulfate and the like;

(4) Biodegradable quaternary ammonium salts such as N,N-di(tallowoyl-oxy-ethyl)-N,N-dimethyl ammonium methyl sulfate and N,N-di(tallowoyl-oxy-propyl)-N,N-dimethyl ammonium methyl sulfate. Biodegradable quaternary ammonium salts are described, for example, in U.S. Pat. Nos. 4,137,180, 4,767,547 and 4,789,491 incorporated by reference herein.

Preferred biodegradable quaternary ammonium salts include the biodegradable cationic diester compounds as described in U.S. Pat. No. 4,137,180, herein incorporated by reference. (ii) Tertiary fatty amines having at least one and preferably two C₈ to C₃₀, preferably C₁₂ to C₂₂ alkyl chains. Examples include hardened tallow-di-methylamine and cyclic amines such as 1-(hydrogenated tallow)amidoethyl-2-(hydrogenated tallow)imidazoline. Cyclic amines, which may be employed for the compositions herein, are described in U.S. Pat. No. 4,806,255 incorporated by reference herein.

(iii) Carboxylic acids having 8 to 30 carbons atoms and one carboxylic group per molecule. The alkyl portion has 8 to 30, preferably 12 to 22 carbon atoms. The alkyl portion may be linear or branched, saturated or unsaturated, with linear saturated alkyl preferred. Stearic acid is a preferred fatty acid for use in the composition herein. Examples of these carboxylic acids are commercial grades of stearic acid and palmitic acid, and mixtures thereof, which may contain small amounts of other acids.

(iv) Esters of polyhydric alcohols such as sorbitan esters or glycerol stearate. Sorbitan esters are the condensation products of sorbitol or iso-sorbitol with fatty acids such as stearic acid. Preferred sorbitan esters are monoalkyl. A common example of sorbitan ester is SPAN® 60 (ICI) which is a mixture of sorbitan and isosorbide stearates.

(v) Fatty alcohols, ethoxylated fatty alcohols, alkylphenols, ethoxylated alkylphenols, ethoxylated fatty amines, ethoxylated monoglycerides and ethoxylated diglycerides.

(vi) Mineral oils, and polyols such as polyethylene glycol.

These softeners are more definitively described in U.S. Pat. No. 4,134,838 the disclosure of which is incorporated by reference herein. Preferred fabric softeners for use herein are acyclic quaternary ammonium salts. Mixtures of the above mentioned fabric softeners may also be used.

The above described compositions (C1), (C2), (C3) or (C4) may be in solid or liquid form. Preferably the compositions are in solid form.

A further embodiment of the present invention relates to detergent formulations (DF1) comprising
(a) at least one composition (C1), (C2), (C3) or (C4),
(b) at least one surfactant and
(c) optionally at least one further auxiliary.

The surfactant (b) may be anionic or nonionic.

Examples for suitable anionic surfactants are sulfate, sulfonate or carboxylate surfactant or a mixture of those surfactants. Preferred sulfates are those having from 12 to 22 carbon atoms in the alkyl radical, where appropriate in combination with alkyl ethoxysulfates having from 10 to 20 carbon atoms in the alkyl radical. Preferred sulfonates are, for example, alkylbenzenesulfonates having from 9 to 20 carbon atoms in the alkyl radical and/or alkylnaphthalenesulfonates having from 6 to 20 carbon atoms in the alkyl radical. The cation in the anionic surfactant is preferably an alkali metal cation, especially sodium. Preferred carboxylates are alkali metal sarcosinates of the formula
R₁₅—CO—N(R₁₆)—CH₂COOM₁, wherein

R₁₅ is alkyl or alkenyl having from 8 to 20 carbon atoms in the alkyl or alkenyl radical,

R₁₆ is C₁-C₄alkyl and

M₁ is an alkali metal.

Examples for suitable non-ionic surfactants are condensation product of from 3 to 8 mols of ethylene oxide with 1 mol of primary alcohol containing from 9 to 20 carbon atoms.

Further auxiliaries (c) are for examples builder substances; peroxides; suspending agents for dirt, e.g. sodium carboxymethyl cellulose; pH regulators, e.g. alkali metal or alkaline earth metal silicates; foam regulators, e.g. soap; salts for regulating the spray-drying and the granulating properties, e.g. sodium sulfate; fragrances; antistatic agents; fabric conditioners; enzymes, such as amylase, cellulase and protease; bleaching agents; pigments and/or toning agents.

In addition, the washing agent compositions according to the invention may also comprise so-called perborate activators, such as, for example, TAED or TAGU. Preference is given to TAED, which is preferably used in an amount of from 0.05 to 5 wt-%, especially from 0.2 to 1.7 wt-%, based on the total weight of the detergent formulation.

There come into consideration as builder substance, for example, alkali metal phosphates, especially tripolyphosphates, carbonates or hydrogen carbonates, especially the sodium salts, silicates, aluminium silicates, polycarboxylates, polycarboxylic acids, organic phosphonates, aminoalkylenepoly(alkylenephosphonates) or mixtures of those compounds. Especially suitable silicates are sodium salts of crystalline silicates having layered structures of the formula NaHSiₜO₂ₜ₊₁⁻pH₂O or Na₂SiₜO₂ₜ₊₁⁻pH₂O, wherein t is a number from 1.9 to 4 and p is a number from 0 to 20. Among the aluminium silicates, preference is given to those obtainable commercially under the names zeolite A, B, X and HS, and also to mixtures comprising two or more of those components.

Among the polycarboxylates, preference is given to polyhydroxycarboxylates, especially citrates, and acrylates and also copolymers thereof with maleic anhydride. Preferred polycarboxylic acids are nitrilotriacetic acid, ethylenediaminetetraacetic acid and ethylenediamine disuccinate either in racemic form or in the enantiomerically pure S,S form. Phosphonates and aminoalkylenepoly(alkylenephosphonates) that are especially suitable are alkali metal salts of 1-hydroxyethane-1,1-diphosphonic acid, nitrilotris(methylenephosphonic acid), ethylenediaminetetramethylenephosphonic acid and diethylenetriaminepentamethylenephosphonic acid.

There come into consideration as the peroxide component, for example, the organic and inorganic peroxides known in the literature and available commercially that bleach textile materials at conventional washing temperatures, for example at from 10 to 95° C. The organic peroxides are, for example, mono- or poly-peroxides, especially organic peracids or salts thereof, such as phthalimidoperoxycaproic acid, peroxybenzoic acid, diperoxydodecanoic diacid, diperoxynonanoic diacid, diperoxydecanoic diacid, diperoxyphthalic acid or salts thereof. Preferably, however, inorganic peroxides are used, such as, for example, persulfates, perborates, percarbonates and/or persilicates. It will be understood that mixtures of inorganic and/or organic peroxides can also be used. The peroxides may be in a variety of crystalline forms and have different water contents, and they may also be used together with other inorganic or organic compounds in order to improve their storage stability. The peroxides are added to the washing agent composition preferably by mixing the components, for example using a screw metering system and/or a fluidised bed mixer.

Preferred enzymes are cellulases, proteases, amylases and lipases. Preferred enzymes are cellulases and proteases, especially proteases. Cellulases are enzymes which act on cellulose and its derivatives and hydrolyze them into glucose, cellobiose, cellooligosaccharide. Cellulases remove dirt and have the effect of mitigating the roughness to the touch. Examples of enzymes to be used include, but are by no means limited to, the following:

proteases as given in U.S. Pat. No. B-6,242,405, column 14, lines 21 to 32;

lipases as given in U.S. Pat. No. B-6,242,405, column 14, lines 33 to 46;

amylases as given in U.S. Pat. No. B-6,242,405, column 14, lines 47 to 56; and

cellulases as given in U.S. Pat. No. B-6,242,405, column 14, lines 57 to 64.

The enzymes can optionally be present in the detergent compositions. When used, the enzymes are usually present in an amount of 0.01-5 wt-%, preferably 0.05-5 wt-% and more preferably 0.1-4 wt-%, based on the total weight of the detergent composition.

A preferred detergent formulation (DF2) consists of
(i) from 0.01 to 10 wt-%, preferably 0.01 to 5 wt-%, based on the total weight of the detergent formulation, of at least one composition (C1), (C2), (C3) or (C4) and
ii) from 5 to 70 wt-%, based on the total weight of the detergent formulation, of at least one anionic surfactant from the group consisting of alkylbenzenesulfonates having from 9 to 20 carbon atoms in the alkyl radical; alkylnaphthalenesulfonates having from 6 to 20 carbon atoms in the alkyl radical; and alkali metal sarcosinates of the formula
   R₁₅—CO—N(R₁₆)—CH₂COOM₁, wherein
   R₁₅ is alkyl or alkenyl having from 8 to 20 carbon atoms in the alkyl or alkenyl radical,
   R₁₆ is C₁-C₄alkyl and
   M₁ is an alkali metal
   and/or
   at least one non-ionic surfactant from the group consisting of condensation products of from 3 to 8 mols of ethylene oxide with 1 mol of primary alcohol containing from 9 to 20 carbon atoms,
iiia) from 5 to 60 wt-%, based on the total weight of the detergent formulation, of a builder substance from the group consisting of alkali metal phosphates; carbonates; hydrogen carbonates; silicates; aluminium silicates; polycarboxylates; polycarboxylic acids; organic phosphonates and aminoalkylenepoly(alkylenephosphonates), and
iiib) from 0 to 30 wt-%, based on the total weight of the detergent formulation, of a peroxide from the group consisting of organic mono- or poly-peroxides; organic peracids and salts thereof; persulfates; perborates; percarbonates and persilicates,
iiic) from 0 to 60 wt-%, based on the total weight of the detergent formulation, of further additives from the group consisting of optical brighteners; suspending agents for dirt;

pH regulators; foam regulators; salts for regulating the spray-drying and granulating properties; fragrances; antistatic agents; fabric conditioners; enzymes; bleaching agents; pigments; toning agents; and perborate activators, and
iv) from 0 to 5 wt-%, based on the total weight of the detergent formulation, water.

The detergent formulations (DF1) and (DF2) according to the invention may be in solid, liquid, gel-like or paste-like form, for example in the form of a liquid, non-aqueous washing agent composition containing not more than 5 wt-%, preferably from 0 to 1 wt-%, water and based on a suspension of a builder substance in a non-ionic surfactant, for example as described in GB-A-2 158 454.

The detergent formulations (DF1) and (DF2) according to the invention may also be in the form of powders or (super-)compact powders, in the form of single- or multi-layer tablets (tabs), in the form of washing agent bars, washing agent blocks, washing agent sheets, washing agent pastes or washing agent gels, or in the form of powders, pastes, gels or liquids used in capsules or in pouches (sachets).

A further embodiment of the present invention relates to the use of compositions (C1), (C2), (C3) and (C4) or formulations (DF1), (DF2) for the treatment of textiles.

This detergent treatment of textiles can be conducted as a domestic treatment in normal washing machines.

The textile fibres treated may be natural or synthetic fibres or mixtures thereof. Examples of natural fibres include vegetable fibres such as cotton, viscose, flax, rayon or linen, preferably cotton and animal fibres such as wool, mohair, cashmere, angora and silk, preferably wool. Synthetic fibres include polyester, polyamide and polyacrylonitrile fibres. Preferred textile fibres are cotton, polyamide and wool fibres, especially cotton fibres. Preferably, textile fibres treated according to the method of the present invention have a density of less than 1000 g/m², especially less than 500 g/m² and most preferred less than 250 g/m².

The process is usually conducted in the temperature range of from 5 to 100° C., especially 5 to 60° C. Preferred is a temperature range of 5 to 40° C., especially 5 to 35° C. and more preferably 5 to 30° C.

The detergent compositions herein will preferably be formulated such that, during use in aqueous cleaning operations, the wash water will have a pH of between about 6.5 and about 11, preferably between about 7.5 and 11. Laundry products are typically at pH 9-11. Techniques for controlling pH at recommended usage levels include the use of buffers, alkalis, acids, etc., and are well known to those skilled in the art.

Machine laundry methods herein typically comprise treating soiled laundry with an aqueous wash solution in a washing machine having dissolved or dispensed therein an effective amount of a machine laundry detergent composition in accordance with the invention. By an effective amount of the detergent composition it is meant, e.g., from 10 g to 300 g of product dissolved or dispersed in a wash solution of volume from 5 to 85 litres, as are typical product dosages and wash solution volumes commonly employed in conventional machine laundry methods. Examples are

top-loading, vertical axis U.S.-type automatic washing machines using about 45 to 83 liters of water in the wash bath, a wash cycle of about 10 to about 14 minutes and a wash water temperature of about 10 to about 50° C.;

front-loading, horizontal-axis European-type automatic washing machine using about 8 to 15 liters of water in the wash bath, a wash cycle of about 10 to about 60 minutes and a wash water temperature of about 30 to about 95° C.;

top-loading, vertical-axis Japanese-type automatic washing machine using about 26 to 52 liters of water in the wash bath, a wash cycle of about 8 to about 15 minutes and a wash water temperature of about 5 to about 25° C.

The liquor ratio is preferably 1:3 to 1:40, especially 1:3 to 1:30. Highly preferred is a liquor ratio of 1:3 to 1:25.

The following Examples serve to illustrate the invention but do not limit the invention thereto. Parts and percentages relate to weight, unless otherwise indicated. Temperatures are in degrees Celsius, unless otherwise indicated.

### APPLICATION EXAMPLES

Detergent formulation comprising dye fixing or dye transfer inhibition agents

For the Example 1-4 the following detergent formulations are used:

Detergent 1 (D1):

| | |
|---|---|
| 8.0% | Sodium alkyl benzol sulfonate |
| 2.9% | Tallow alcohol-tetradecane-ethylene glycol ether (14 mols EO) |
| 3.5% | Sodium soap |
| 43.8% | Sodium triphosphate |
| 7.5% | Sodium silicate |
| 1.9% | Magnesium silicate |
| 1.2% | Carboxymethylcellulose |
| 0.2% | EDTA |
| 21.2% | Sodium sulfate |
| 9.8% | water |

Detergent 2 (D2):

| | |
|---|---|
| 9.7% | Linear sodium alkyl benzene sulfonate (mean C-chain length |
| | C_{11,5}) |
| 5.2% | Ethoxylated fatty alcohol C₁₂-C₁₈ (7 EO) |
| 3.6% | Sodium soap (chain length C₁₂-C₁₈: 65% &, C₂₀-C₂₂: 35%) |
| 6.5% | SIK (Foam inhibitor) |
| 32.5% | Sodium aluminium silicate (zeolites 4A) |
| 11.8% | Sodium carbonate |
| 5.2% | Sodium salt of a copolymer from acrylic and maleic acid |
| | (Sokalan CP5 (BASF)) |
| 3.4% | Sodium silicate |
| 1.3% | Carboxymethylcellulose |
| 0.8% | Diethylene triamine penta (methylene phosphonic acid) |
| | (Dequest 2060 (Monsanto)) |
| 7.8% | Sodium sulfate |
| 12.2% | water |

Detergent 3 (liquid Detergent Formulation) (D3):

| | |
|---|---|
| 2.5% | Sodium alkyl benzol sulfonate |
| 20% | Ethoxylated fatty alcohol |
| 13% | Soap |
| 2.5% | Citric acid |
| Reminder | Water |

Detergent 4 (D4):

| | |
|---|---|
| 3% | Sodium alkyl benzol sulfonate |
| 8% | Ethoxylated fatty alcohol |
| 3% | Soap |
| 44% | sodium tripolyphosphate (STPP) |

Reminder Silicate, Sodium Sulfate

In Example 2-4, 0.75 wt-% of the following dyefixing or dye transfer inhibiton agents
(a) Tinofix CL® (Ciba Specialty Chemicals)
(b) Sokalan HP 53® (BASF)
(c) Sokalan HP 56® (BASF)
(d) Chromabond S-100® (ISP)
(e) Chromabond S400® (ISP)

are added to the detergent formulations. The weight percentages relate to the active matter of these compounds and are based on the total weight of the detergent formulation.

The following washing procedure is used for Examples 1-4

5 g of bleached cotton fabric (weave) are washed/rinsed in a linitest applying the following conditions:

Main wash:

| | |
|---|---|
| Detergent formulation dosage: | 2.5 g/l |
| Liquor ratio: | 1:10 |
| Duration: | 15 minutes |
| Temperature: | 30° C. |

The fabric is spin dried at 60° C.; 1 and 3 wash cycles.

In all Examples, the whiteness is measured by the Ganz/Griesser-method.

### Example 1

### Detergent Formulation Comprising FWA of formula (I), (II) or (III) but Without Dye Fixing or Dye Transfer Inhibition Agent

To the detergent formulations D1, D2, D3 and D4,

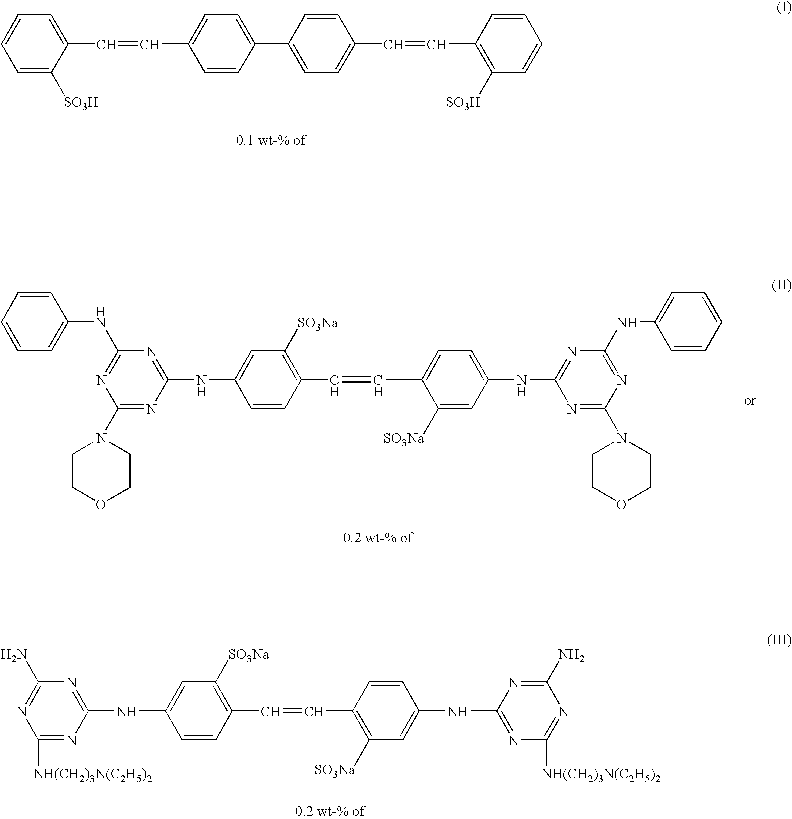

are added to the detergent formulation. The weight percentages relate to the active matter of these compounds and are based on the total weight of the detergent formulation.

TABLE 1
Degree of whitness after 3 wash cycles

| | D1 | D2 | D3 | D4 |
|---|---|---|---|---|
| 0.2 wt-% (I) | 196 | 196 | 134 | 196 |
| 0.2 wt-% of (II) | 202 | 202 | 140 | 197 |
| 0.1 wt-% of (III) | 209 | 210 | 137 | 195 |

### Example 2

### Detergent Formulation Comprising a FWA of Formula (I) and Dye Fixing or Dye Transfer Inhibition Agent (Comparative Example)

To the detergent formulations D1, D2, D3 and D4,

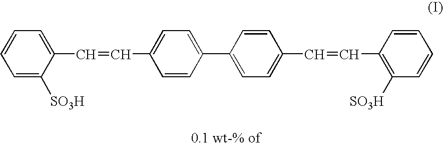

are added to the detergent formulation. The weight percentages relate to the active matter of these compounds and are based on the total weight of the detergent formulation.

TABLE 2
Degree of whitness after 3 wash cycles

| | D1 and (I) | D2 and (I) | D3 and (I) | D4 and (I) |
|---|---|---|---|---|
| Tinofix CI | 137 | 153 | 110 | 114 |
| Sokalan HP 53 | 201 | 201 | 129 | 188 |
| Sokalan HP 56 | 166 | 163 | 95 | 157 |
| Chromabond S-100 | 186 | 186 | 128 | 177 |
| Chromabond S-400 | 180 | 177 | 106 | 171 |

TABLE 3
Difference between the whitness obtained by the detergent with FWA
only and the whiteness obtained by the detergent with FWA and dyefixing
or dye transfer inhibition agents after 3 wash cycles

| | D1 and (I) | D2 and (I) | D3 and (I) | D4 and (I) |
|---|---|---|---|---|
| Tinofix CI | −71 | −57 | −27 | −82 |
| Sokalan HP 53 | −8 | −9 | −7 | −7 |
| Sokalan HP 56 | −42 | −47 | −41 | −38 |
| Chromabond S-100 | −23 | −24 | −9 | −19 |
| Chromabond S-400 | −29 | −32 | −30 | −24 |

### Example 3

### Detergent Formulation Comprising a FWA of Formula (II) and Dye Fixing or Dye Transfer Inhibition Agent (Comparative Example)

To the detergent formulations D1, D2, D3 and D4,

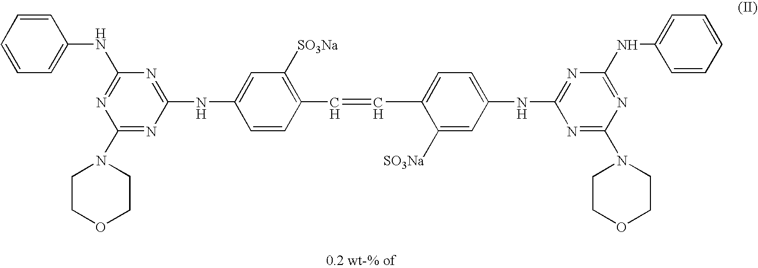

are added to the detergent formulation. The weight percentages relate to the active matter of these compounds and are based on the total weight of the detergent formulation.

TABLE 4
Degree of whitness after 3 wash cycles

| | D1 and | | | |
|---|---|---|---|---|
| | (II) | D2 and (II) | D3 and (II) | D4 and (II) |
| Tinofix CI | 136 | 132 | 105 | 133 |
| Sokalan HP 53 | 198 | 195 | 118 | 193 |
| Sokalan HP 56 | 164 | 151 | 80 | 165 |
| Chromabond S-100 | 180 | 179 | 126 | 169 |
| Chromabond S-400 | 148 | 142 | 93 | 134 |

TABLE 5
Difference between the whitness obtained by the detergent with FWA only
and the whiteness obtained by the detergent with FWA and dyefixing or
dye transfer inhibition agents after 3 wash cycles

| | D1 and | | | |
|---|---|---|---|---|
| | (II) | D2 and (II) | D3 and (II) | D4 and (II) |
| Tinofix CI | −67 | −70 | −35 | −64 |
| Sokalan HP 53 | −4 | −8 | −22 | −5 |
| Sokalan HP 56 | −38 | −52 | −60 | −33 |
| Chromabond S-100 | −22 | −24 | −14 | −29 |
| Chromabond S-400 | −55 | −60 | −47 | −63 |

### Example 4

### Detergent Formulation Comprising a FWA of Formula (III) and Dye Fixing or Dye Transfer Inhibition Agent

TABLE 6
Degree of whitness after 3 wash cycles

| | D1 and | | | |
|---|---|---|---|---|
| | (III) | D2 and (III) | D3 and (III) | D4 and (III) |
| Tinofix CI | 196 | 199 | 131 | 195 |
| Sokalan HP 53 | 199 | 200 | 135 | 199 |
| Sokalan HP 56 | 191 | 187 | 122 | 187 |
| Chromabond S-100 | 196 | 198 | 133 | 195 |
| Chromabond S-400 | 189 | 189 | 133 | 185 |

TABLE 7
Difference between the whitness obtained by the detergent with
FWA only and the whiteness obtained by the detergent with FWA
and dyefixing or dye transfer inhibition agents after 3 wash cycles

| | D1 and (III) | D2 and (III) | D3 and (III) | D4 and (III) |
|---|---|---|---|---|
| Tinofix CI | 0 | 3 | −3 | −1 |
| Sokalan HP 53 | 3 | 3 | 1 | 2 |
| Sokalan HP 56 | −5 | −10 | −12 | −9 |
| Chromabond | 0 | 2 | −1 | −2 |
| S-100 | | | | |
| Chromabond | −7 | −8 | −2 | −11 |
| S-400 | | | | |

### Application Example 5

### Detergent Formulation Comprising Fabric Softening Agents

In Example 5, the following Softergent S1 (a detergent formulation comprising a softener agent):

Softergent S1:

| | |
|---|---|
| 20 wt-% | Ethoxylated fatty alcohol |
| 54 wt-% | Zeolite A |
| 20 wt-% | Sodium Carbonate |
| 6 wt-% | Arquat 2HT-75 (softener agent) |

In Example 5, the following washing procedure is used:

5 g of bleached cotton fabric (weave) are washed/rinsed in a linitest applying the following conditions:

Main Wash:

| | |
|---|---|
| Softergent dosage: | 0.83 g/l |
| Liquor ratio: | 1:30 |
| Wash temperature: | 25° C.; |
| Water Hardness: | 3° dH approx. 50 ppm CaCO₃ |
| Duration: | 12 Minutes |

Rinse Bath:

| | |
|---|---|
| Liquor Ratio: | 1:30 |
| Temperature: | 25° C.; |
| Water Hardness: | 3° dH approx. 50 ppm CaCO₃ |
| Duration: | 4 Minutes |

The fabric is washed with
(a) the softergent formulation (S1) as such,
(b) the softergent formulation (S1) comprising 0.2 wt-% of a FWA of formula (I)=Comparative test
(c) the softergent formulation (S1) comprising 0.2 wt-% of a FWA of formula (III)

The whiteness of the fabric has been measured after 1 and after 3 wash cycles.

TABLE 8
Degree of whitness after 1 or 3 wash cycles

| | After 1 wash cycle | After 3 wash cycles |
|---|---|---|
| (a) | 74 | 76 |
| (b) | 83 | 93 |
| (c) | 118 | 140 |

1. A composition comprising
(i) at least one compound of formula (1) 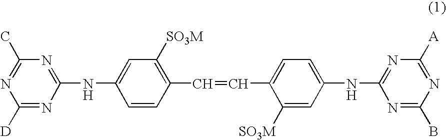
wherein A signifies the moiety of formula (2) or (3) 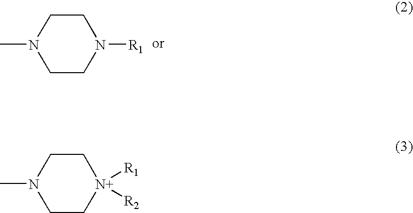
in which
R₁ represents hydrogen; straight-chain C₁-C₁₂alkyl, which may be substituted by one or two —OH, —OC₁-C₄alkyl, —NH₂, —NHC₁-C₄alkyl, —N(C₁-C₄alkyl)₂, —N-pyrrolidino, —N-piperidino, —N-morpholino or —N⁺(C₁-C₄alkyl)₃ groups; branched C₃-C₁₂alkyl group, which may be interrupted by one or two heteroatoms and which may be unsubstituted or substituted by one or two —OH, —OC₁-C₄alkyl, —NH₂, —NHC₁-C₄alkyl, —N(C₁-C₄alkyl)₂, —N-pyrrolidino, —N-piperidino, —N-morpholino or —N⁺(C₁-C₄alkyl)₃ groups; and
R₂ represents C₁-C₄alkyl; C₂-C₄hydroxyalkyl; —CH₂CONH₂; —CH₂COOH or —CH₂COOC₁-C₄alkyl or
A represents a group of the formulae 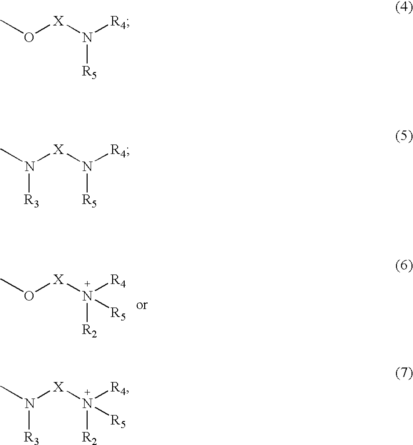
in which
R₃, R₄ and R₅ each, independently of each other, represent hydrogen; C₁-C₄alkyl; C₂-C₄hydroxyalkyl; the group —X′—NR₆R₇ or the group —X′—N⁺R_{6′}R₆R₇, whereby at least one of the substituents R₄ and/or R₅ represents —X′—NR₆R₇ or —X′—N⁺R_{6′}R₆R₇,
X and X′ each, independently of each other, represent a straight-chain C₂-C₈alkylene, which is unsubstituted or substituted by one or two —OH; or branched C₃-C₈alkylene chain, which is unsubstituted or substituted by one or two —OH; —C(═O)—; or a 5-or 6-membered cycloaliphatic ring,
R₆, R_{6′} and R₇ each, independently of each other, represent hydrogen; C₁-C₄alkyl; or, together with the nitrogen atom to which they are bound, complete a pyrrolidino, piperidino or morpholino ring and
R₂ is as previously defined or
A is NR₈R₉,
wherein
R₈ and R₉ each independently of each other, represent hydrogen; C₁-C₈alkyl, wherein the alkyl group may be substituted by C₁-C₄alkoxy, amino, mono- or di-C₁-C₄alkylamino or tri-C₁-C₄alkylammonium; C₂-C₄hydroxyalkyl, wherein the alkyl group may be substituted by C₁-C₄alkoxy, amino, mono- or di-C₁-C₄alkylamino or tri-C₁-C₄alkylammonium; C₁-C₄alkoxyC₁-C₄alkyl; phenyl, which is unsubstituted or substituted by halogen, C₁-C₄alkoxy, C₁-C₄alkyl, COOM, SO₃M or sulphonamido, or
R₈ and R₉, together with the nitrogen atom to which they are attached, complete a morpholino-, piperidino- or pyrrolidino-ring, or
A represents halogen,
B and C have independently from each other and from A the same meanings as defined for A, and
D has independently from A the same meanings as defined for A with the exception that D is not halogen, and
M is hydrogen; an alkali metal atom, ammonium or a cation formed from an amine; or a quaternised form thereof,
and
(ii) at least one dyefixing, dye transfer inhibition and/or fabric softening agent.

2. A composition according to claim 1 comprising
(i) at least one compound of formula (8) 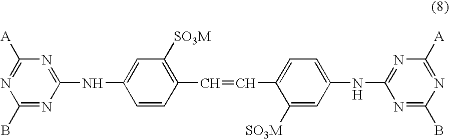
in which
each B is the same or different and each is —NH-Z-N(Rₐ)(R_{b}) or —N-[Z-N(Rₐ)(R_{b})]₂ in which Z is C₂-C₁₄alkylene or optionally substituted arylene, Rₐ and R_{b} are the same or different and each is C₁-C₁₂alkyl, or Rₐ and R_{b}, together with the nitrogen atom to which they are each attached, form a morpholino, piperidino or piperazino ring; and
A is NH₂; NH(C₁-C₄alkyl); N(C₁-C₄alkyl)₂; N(CH₂CH₂OH)₂; O-C₁-C₄alkyl; 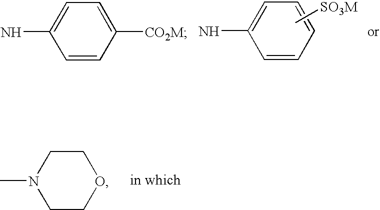
M is hydrogen; an alkali metal atom, ammonium or a cation formed from an amine; or a quaternised form thereof.

3. A composition according to claim 1 comprising at least one compound of formula (9) 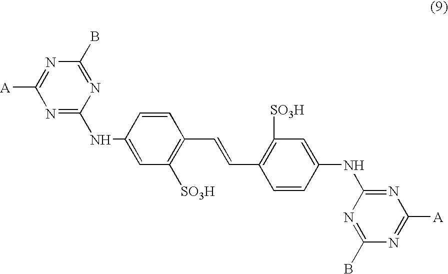
wherein
each A independently of one another, represent the moiety 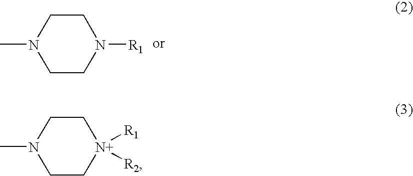
in which
R₁ represents hydrogen; a straight-chain C₁-C₁₂alkyl or branched C₃-C₁₂alkyl group which
C₂-C₁₂alkyl and C₃-C₁₂alkyl group, respectively, may be interrupted by one or two heteroatoms and is unsubstituted or substituted by one or two —OH, —OC₁-C₄alkyl, —NH₂, —NHC₁-C₄alkyl, —N(C₁-C₄alkyl)₂, —N-pyrrolidino, —N-piperidino, —N-morpholino or —N⁺(C₁-C₄alkyl)₃ groups and
R₂ represents C₁-C₄alkyl; C₂-C₄hydroxyalkyl; —CH₂CONH₂; —CH₂COOH or —CH₂COOC₁-C₄alkyl or, alternatively,
each A independently of one another, represent a group of the formula 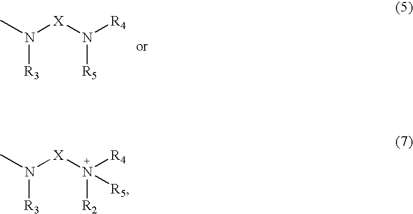
in which
R₃, R₄ and R₅ each, independently of each other, represent hydrogen; C₁-C₄alkyl; C₂-C₄hydroxyalkyl; the group —X′—NR₆R₇ or the group —X′—N⁺R_{6′}R₆R₇, whereby at least one of the substituents R₄ and/or R₅ represents —X′—NR₆R₇ or —X′—N⁺R_{6′}R₆R₇,
X and X′ each, independently of each other, represent a straight-chain C₂-C₈alkylene or branched C₃-C₈alkylene chain, which is unsubstituted or substituted by one or two —OH or —C(═O)— groups,
R₆, R_{6′} and R₇ each, independently of each other, represent hydrogen; C₁-C₄alkyl or, together with the nitrogen atom to which they are bound, complete a pyrrolidino, piperidino or morpholino ring and
R₂ is as previously defined and each
each B independently of one another, is either defined as for A or represent halogen; —NH₂; C₁-C₄monoalkyl- or dialkylamino, said alkyl groups being unsubstituted or substituted by C₁-C₄alkoxy, amino, mono- or di-C₁-C₄alkylamino or tri-C₁-C₄alkylammonium; C₂-C₄hydroxyalkylamino; C₂-C₄di(hydroxyalkyl)amino; anilino; an aniline monosulphonic acid or sulphonamide residue or a 5- or 6-membered, saturated heterocyclic ring.

4. A composition according to claim 1 comprising at least one compound of formulae (10), (11), and/or (12) 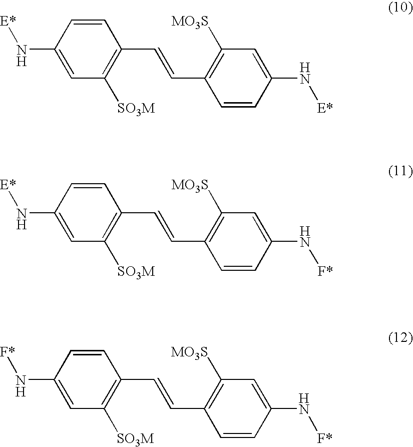
in which
E* represents a group of the formula 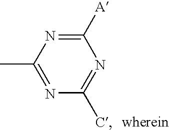
wherein
A′ represents —X—Y—NR₃R₄ and
C′ is —NR₁R₂ and
F* represents a group of the formula 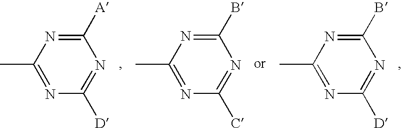
wherein
D′ represents —NR₃R₆ and
B′ represents —X₁—Y₁—NR₇R₈, whereby
X and X₁ each, independently of each other, represent —O— or —NH—,
Y and Y₁ each, independently of each other, represent a straight-chain C₂-C₈alkylene or branched C₃-C₈alkylene chain, which may be interrupted by one or two nitrogen, oxygen or sulphur atoms or represent a 5- or 6-membered cycloaliphatic ring, preferably cyclohexyl,
R₁, R₂, R₅ and R₆ each independently of each other, represent hydrogen; C₁-C₈alkyl; C₂-C₄hydroxyalkyl; C₁-C₄alkoxyC₁-C₄alkyl; phenyl, which is unsubstituted or substituted by halogen, C₁-C₄alkoxy, C₁-C₄alkyl or sulphonamido, or
R₁ and R₂ and/or R₅ and R₆, together with the nitrogen atom to which they are attached, complete a morpholino-, piperidino- or pyrrolidino-ring,
R₃, R₄, R₇ and R₈ each independently of each other, represent hydrogen, C₁-C₄alkyl, C₂-C₄hydroxyalkyl or
R₃ and R₄ and/or R₇ and R₈, together with the nitrogen atom to which they are attached, complete a morpholino-, piperidino- or pyrrolidino-ring and
M represents hydrogen, an alkaline or alkaline earth metal, ammonium or alkyl ammonium.

5. A composition according to claim 1 comprising
(ii) at least one polymeric dye transfer inhibitor agent.

6. A composition according to claim 5, wherein the polymeric dye transfer inhibitor is selected from the group consisting of polyvinylpyrrolidones, polyvinylimidazole and polyvinylpyridine-N-oxides which may have been modified by the incorporation of anionic or cationic substituents.

7. A composition according to claim 1 comprising (ii) at least one dye-fixing agent based on basic polycondensation products of an amine of formula (13) 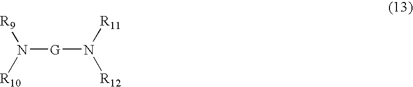
and a cyanamide, which polycondensation products are completely or partially neutralised with an inorganic or organic acid,
R₉, R₁₀, R₁₁ and R₁₂ each independently of the others being hydrogen or alkyl that is unsubstituted or substituted by amino, hydroxy, cyano or by C₁-C₄alkoxy and G being alkylene optionally substituted or interrupted by one or more hetero atoms.

8. A composition according to claim 7, wherein G is C₂-C₂₀alkylene optionally interrupted by —O—, —S—, —NH— or by —N(C₁-C₄alkyl)- and/or substituted by hydroxy.

9. A composition according to claim 7, wherein R₉, R₁₀, R₁₁ and R₁₂ are each independently of the others hydrogen or C₁-C₄alkyl.

10. A composition according to claim 7, wherein cyanamides are cyanamide, dicyandiamide, guanidine or biguanidine or mixtures thereof.

11. A detergent formulation comprising
(i) at least one composition according to claim 1,
(ii) at least one surfactant and
(iii) optionally at least one further auxiliary.

12. A detergent formulation according to claim 11 comprising
(i) from 0.01 to 10 wt-%, based on the total weight of the detergent formulation, of at least one composition according to claim 11 and
ii) from 5 to 70 wt-%, based on the total weight of the detergent formulation, of at least one anionic surfactant from the group consisting of alkylbenzenesulfonates having from 9 to 20 carbon atoms in the alkyl radical; alkylnaphthalenesulfonates having from 6 to 20 carbon atoms in the alkyl radical; and alkali metal sarcosinates of the formula
R₁₅—CO—N(R₁₆)—CH₂COOM₁, wherein
R₁₅ is alkyl or alkenyl having from 8 to 20 carbon atoms in the alkyl or alkenyl radical,
R₁₆ is C₁-C₄alkyl and
M₁ is an alkali metal
and/or
at least one non-ionic surfactant from the group consisting of condensation products of from 3 to 8 mols of ethylene oxide with 1 mole of primary alcohol containing from 9 to 20 carbon atoms,
iiia) from 5 to 60 wt-%, based on the total weight of the detergent formulation, of a builder substance from the group consisting of alkali metal phosphates; carbonates; hydrogen carbonates; silicates; aluminium silicates; polycarboxylates; polycarboxylic acids; organic phosphonates and aminoalkylenepoly(alkylenephosphonates), and
iiib) from 0 to 30 wt-%, based on the total weight of the detergent formulation, of a peroxide from the group consisting of organic mono- or poly-peroxides; organic peracids and salts thereof; persulfates; perborates; percarbonates and persilicates,
iiic) from 0 to 60 wt-%, based on the total weight of the detergent formulation, of further additives from the group consisting of optical brighteners; suspending agents for dirt; pH regulators; foam regulators; salts for regulating the spray-drying and granulating properties; fragrances; antistatic agents; fabric conditioners; enzymes; bleaching agents; pigments; toning agents; and perborate activators, and
iv) from 0 to 5 wt-%, based on the total weight of the detergent formulation, of water.

13. A method of treating textiles comprising contacting said textiles with an effective amount of compositions according to claim 1.

14. A method of treating textiles comprising contacting said textiles with an effective amount of formulations according to claim 11.
